(19) United States
(12) Patent Application Publication
(10) Pub. No.: US 2011/0099121 A1
(43) Pub. Date: Apr. 28, 2011

(54) Internet-Based Tracking Number Visibility for Shipments

(76) Inventors: Scott Brian Holley, Marietta, GA (US); Michael Sadowski, Scarsdale, NY (US); Jessica Morris, Charlotte, NC (US); Steve Powe, Houston, TX (US)

(21) Appl. No.: 12/947,299

(22) Filed: Nov. 16, 2010

Related U.S. Application Data
(63) Continuation of application No. 11/693,577, filed on Mar. 29, 2007.
Application No. 11/693,577 is a continuation-in-part of application No. 11/458,603, filed on Jul. 19, 2006.

(51) Int. Cl. G06Q 10/00

(52) U.S. Cl. 705/333

(57) ABSTRACT

Shipments are tracked in an online integrated logistics system operated by a logistics service provider. A shipment order is received from a shipper. A shipment record corresponding to the order is created in the online integrated logistics system. A web-based interface permits personnel at a shipment location for the shipment to enter a tracking number and status updates corresponding to the shipment. The status updates indicate when a shipment corresponding to the shipment order has been loaded on a trailer, when the trailer is full and when the trailer has been picked up by a carrier. The tracking number and status updates are stored in the shipment record in the online integrated logistics system. The shipment record including the tracking number and status updates is made available to the shipper, the logistics service provider, and the personnel via a web-based user interface.

### RELATED APPLICATIONS

This continuation application claims priority of U.S. application Ser. No. 11/693,577 filed on Mar. 29, 2007, which is hereby incorporated by reference in its entirety.

### FIELD OF THE INVENTION

This invention relates generally to logistics systems. In particular, the present invention relates to the utilization of tracking numbers and related information in shipment tracking.

### BACKGROUND OF THE RELATED ART

Logistics generally involves the planning and management of the shipments of goods by trucking and other carriers. Conventionally, large shippers, such as a manufacturers, manage this process using a Transportation Management System (TMS), which is mostly software, or hire a third party logistics provider (3PL) to manage these and related processes, such as selecting a carrier for a given shipment, for them on an outsourced basis. The third party's services may also include, for example, managing data relating to shipments, determining charges which apply to the shipments, and creating and forwarding invoices for payments between the shipper and carriers. It may also monitor and review shipment data, and enter any additional data required.

The quality of a TMS depends in no small part on the accurate tracking of shipments. FIG. 1 shows an exemplary method of conventional shipment tracking by a 3PL, separated horizontally to identify the parties. The shipper is shown to the left; the carrier is shown to the right; and the logistics service provider is shown in the middle. In this method, a shipper's Enterprise Resource Planning (ERP) system 100 provides a shipment message to the 3PL system 200. The shipment message contains information identifying the shipment, its contents, and, if already selected, the carrier for the shipment. The 3PL system creates a shipment record 200 corresponding to the shipment. The shipment record 200 includes the information contained in the shipment message received from the shipper's ERP system 100 as well as other relevant information. This other information may include, for example, a Bill of Lading number and other information comprising or corresponding to a bill of lading (BoL) for the shipment. The shipment record 200 is also updated with status updates 300 provided by the carrier handling the corresponding shipment. These status updates may be provided in the form of Electronic Data Interchange (EDI) or eXtended Markup Language (XML) messages. The shipment record may also be updated with information inputted by 3PL personnel through a Web interface 210.

The shipment record 200 also includes a tracking number assigned to the shipment. This tracking number may be assigned by the 3PL or by the carrier. Different types of tracking numbers can be utilized in different circumstances. For example, for less-than-truckload (LTL) shipments, where different shipments are loaded onto the same truck in order to maximize the capacity of the truck, so-called PRO numbers are commonly utilized. The tracking number may be represented by a bar code. The bar code may be scanned or otherwise captured using a bar code reader connected to computer at a shipping location, such as a warehouse.

In some instances, the tracking number for the shipment may be assigned by a third party or by personnel associated with the shipper but at a shipping location where the shipper's ERP system 100 cannot be accessed. The location may be a factory, warehouse, or other location at which the shipment originates. This presents a problem that the 3PL system 200 managing the shipment is blind until receipt of the first one of the status updates 300 from the carrier. The 3PL system 200 does not know, for example, the tracking number or the exact status of the shipment at the location since the first one of the status updates 300 from the carrier is often several hours after pickup.

Systems are known which scan the bar code associated with the PRO number and forward the PRO number to the shipper's ERP system or the carrier's system. These are systems conventionally used at the shipping locations. However, there are several disadvantages to these systems. First, in order to track all of the shipments by a shipper, a software application has to be installed in the computer at each shipping location in order to capture and store the tracking number and related information for later reference by personnel at the shipping location. This results in maintenance overhead when the software needs to be updated at multiple shipping locations. Second, the computer and the software application at a shipping location are often limited in their capabilities. It may not be possible to perform sophisticated searching and sorting to find shipments based on multiple search criteria and then view the tracking numbers for those shipments. It also is not possible to view the information in conjunction with other information in the 3PL's shipment record or TMS system. Finally, the information is only available to personnel at the shipping location and personnel at other locations cannot view the information. Concerns about shipping execution were unmet. Management was unable to know if picking, packing and loading was occurring at adequate velocity. There was also difficulty managing the shipments at shipping locations up until shortly after loading.

### BRIEF SUMMARY

It is an object of the preferred embodiments to have a third party shipment tracking system and method that facilitates the entry of tracking number and status updates at shipping locations. It is also desired that the system and method is tightly integrated to a TMS system and, optionally, the tendering process in a logistics system.

The preferred embodiments of the invention thus provide an Internet-based system with an on-line user interface that enables the personnel at shipping locations to collaborate, provide and share tracking number and status updates for shipment data. The status updates indicate when a shipment corresponding to the shipment order has been loaded on a trailer, when the trailer is full and when the trailer has been picked up by a carrier. The system utilizes the Internet so the shipment data is easily accessible from shipper locations anywhere in the world with an ordinary web browser based on user permissions. Online technology is used to help streamline and automate the process in numerous ways.

In the preferred embodiments, shipments are tracked in an online integrated logistics system operated by a logistics service provider. A shipment order is received from a shipper. A shipment record corresponding to the order is created in the online integrated logistics system. A web-based interface permits personnel at a shipment location for the shipment to enter a tracking number and status updates corresponding to the shipment. The tracking numbers and status updates for shipments are entered using an ordinary web browser. The tracking number and status updates are stored in the shipment record in the online integrated logistics system. The shipment record including the tracking number and status updates is made available to the shipper, the logistics service provider, and the personnel via a web-based user interface.

### BRIEF DESCRIPTION OF THE DRAWINGS

FIG. 1 is an overview of a prior art shipment tracking process.

FIG. 2 is an overview of a preferred embodiment of a shipment tracking process according to a preferred embodiment of the invention.

FIG. 3 shows an exemplary screen where a user can search through shipments using multiple criteria and enter the trailer number for a shipment resulting from the search.

FIG. 4 shows an exemplary screen where a user can check the status of a shipment order.

FIG. 5 shows an exemplary screen where the status of a plurality of shipments can be viewed simultaneously.

FIG. 6 shows an exemplary screen where a user can address problems that occur with a shipment.

FIG. 7 shows an exemplary dashboard where basic information regarding the status of a shipment can be viewed.

FIG. 8 shows an exemplary screen for selecting a saved search of shipments.

FIG. 9 shows an exemplary screen displaying the results of a saved search.

FIG. 10 shows an exemplary screen for sorting the results of a saved search.

### DETAILED DESCRIPTION OF THE PREFERRED EMBODIMENTS

The preferred embodiments of the invention are directed to an Internet-based system for managing shipments. An online system streamlines and automates the input of tracking numbers and related information for collaboration by multiple parties. It makes information regarding shipments easily available. The preferred embodiments save time and money by providing increased visibility and automation while improving collaboration between shippers, carriers and third parties, if any.

The preferred embodiments described below utilize the Internet and a web-based online system to exchange documents and other information. Some of these embodiments also include specific technical information, such as message structure and data format. However, the exchange of electronic documents and other information is not limited to the particular message structure and data format.

The preferred embodiments may be carried out as part of or in conjunction with an integrated logistics system such as the system in U.S. Pat. No. 6,915,268, or in U.S. Published Patent Application No. 2002/0049622 by Anthony Lettich et al published on Apr. 25, 2002, each of these patent documents hereby being incorporated by reference in its entirety. The preferred embodiments may also be carried out using a logistics system described in U.S. Pat. No. 6,915,268 combined with the Web Server, Application Server and XML Integration Server (and related aspects) of the system described in the Lettich patent application. However, the invention is not limited in its application to any particular system.

The embodiments of the invention may be applied in any number of different logistics and shipping environments, including the shipment of packaged goods. However, the preferred embodiments described below are most applicable to LTL shipments.

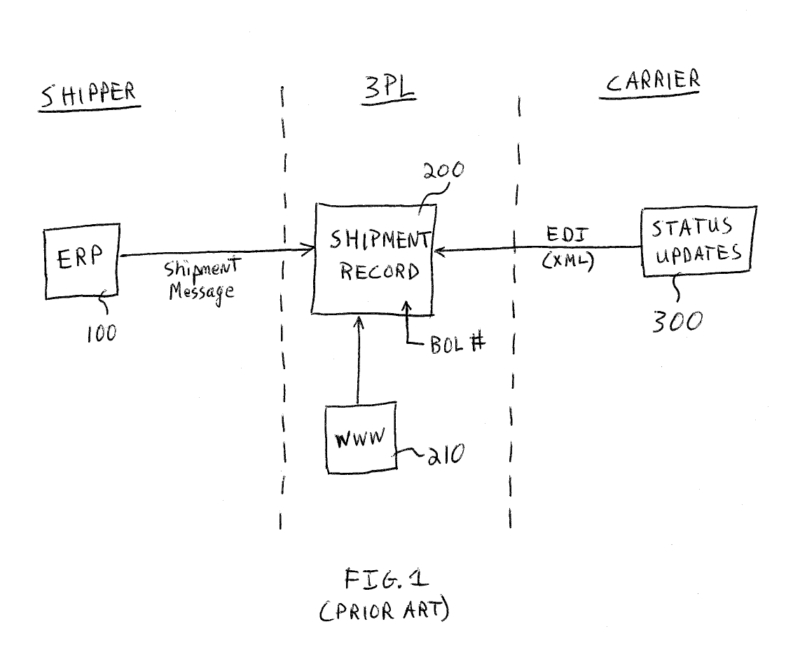

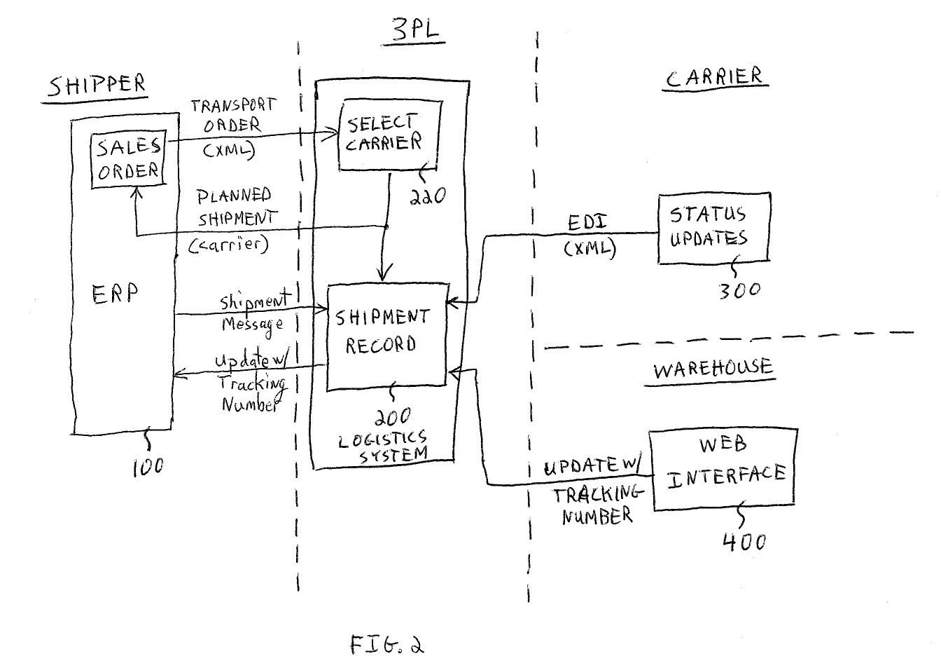

A flowchart providing an overview of an exemplary shipment tracking process according to a preferred embodiment of the invention is shown in FIG. 2. The process is similar in some respects to the process in FIG. 1. However, the process is materially different insofar as it enables personnel at a separate location, such as a warehouse, to input tracking numbers and related information into the online integrated logistics system. Specifically, a user at a separate location can scan a Pro Number into the logistics system using a hand held bar code scanner, and add this as a field into a shipment record or a shipment template. The user, through a web-based interface 400 to the logistics system, can search and sort through shipments based on virtually any field in the shipment data including the warehouse location, expected shipment date, customer for the shipment, and destination. This provides much improved flexibility compared to prior art systems that allow only searching by a single field, the shipment number. This also allows personnel at the location to come up with strategies to minimize the effort to perform the scanning operation, such as searching by any combination of origin location, carrier name and date in order to find all shipments expected to depart from a certain location, on a certain carrier on a certain date, and then scanning all shipments on that carrier one after the other, rather than searching for each shipment number individually, as in the known prior art systems.

In addition, the users are able to enter the trailer number of the truck trailer that the shipment was loaded into. This subsequently allows searches to determine which shipments are in a given trailer, which is useful for prioritizing which trailers the carrier should pull first after the trailers have been loaded. (Often carriers “spot” trailers at a warehouse, meaning they leave a few trailers with no truck cab. They then come by when the trailers are full, attach a cab to it and pull it away.)

A shipment “template” is loaded into and used in the system. This is basically an electronic record describing a shipment that we expect will be shipped. It has not yet been shipped, but is expected to be shipped within several hours or at most a couple of days. The template can originate in the shipper's ERP system, or it can be based on a planned shipment record produced by the 3PL's TMS system after selecting a carrier 220 for the shipment on behalf of the shipper.

The 3PL's logistics system can also send messages to the shipper's ERP system containing the tracking numbers for all shipments scanned. In particular, the 3PL's logistics system can be arranged to send a message to the shipper's ERP system identifying the tracking number for a shipment as soon as the tracking number is entered for that shipment.

The 3PL's logistics system can also receive a subsequent message from the shipper's ERP system representing an executed shipment. This message confirms that from the shipper's point of view, the shipment did in fact occur. The logistics system takes the executed shipment and intelligently merges it with the pre-existing shipment template. During this merge process, certain fields in the Executed Shipment preferably overwrite fields in the Shipment Template. For example, the Executed Shipment may contain the actual weight of the shipment, whereas the Shipment Template contained a planned weight. So the planned weight is overwritten with the actual weight. During the merge process, however, the system must not overwrite certain other fields. For example, the shipper's ERP system may send the 3PL's system an executed shipment message that does not include the tracking number (PRO Number) and trailer number fields, since that system may have no knowledge of those fields. So it is preferable that the 3PL does not overwrite these fields in the shipment record in the 3PL's system—the 3PL's system is the system of record for these fields.

The users can view a dashboard indicating which shipments that are expected to be loaded during the day at a given location have in fact been loaded and which have not. This is preferably done by updating the status of the shipment to reflect the fact that the tracking number has in fact been scanned. This allows management at another location to spot problems (e.g., shipments not being loaded fast enough) and track the progress of the warehouses in real time. The carrier can understand, by looking into the system via the web interface, what is inside trailers that are being loaded for them—which products, the number of pallets and their weights. This allows them to better plan their operations.

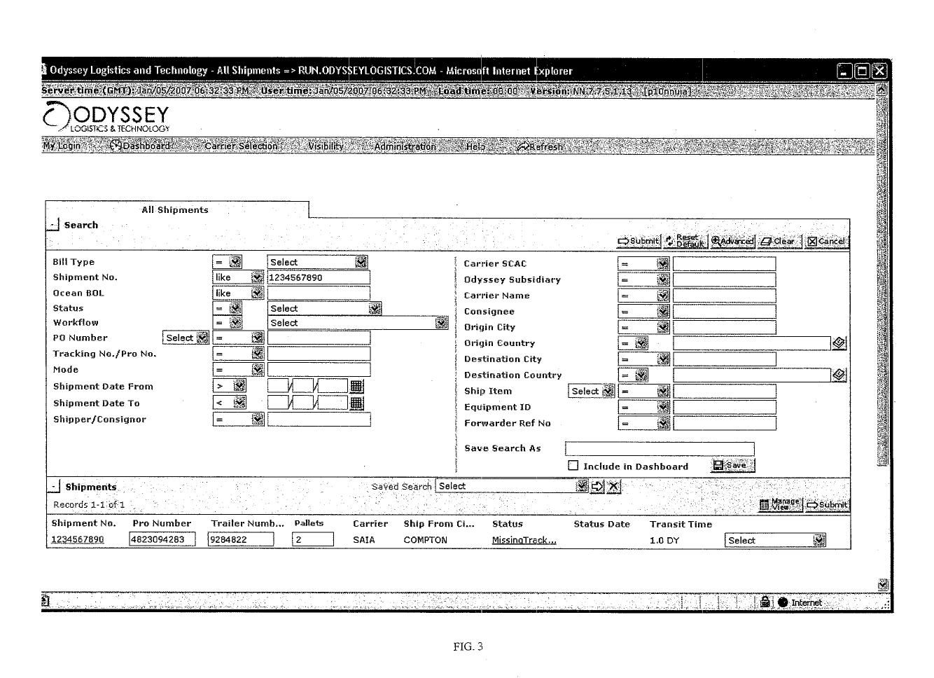

FIG. 3 shows an exemplary screen of a web-based interface for the entry of tracking number and trailer number. As shown, there are a plurality of search fields provided that may be utilized to search for shipments. In FIG. 3, the user enters a specific shipment number “0021592454”. There are preferably Submit, Reset/Default buttons, Advanced Search, Clear and Cancel buttons. With a specific shipment number entered and the search requested by selecting the Submit button, the results of the search will produce only one shipment record. The displayed result includes fields for the tracking number (shown as “Pro Number” in FIG. 3) and trailer number. These numbers can be entered manually using a keyboard or keypad, or they can be scanned in by scanning a corresponding bar code with a bar code reader.

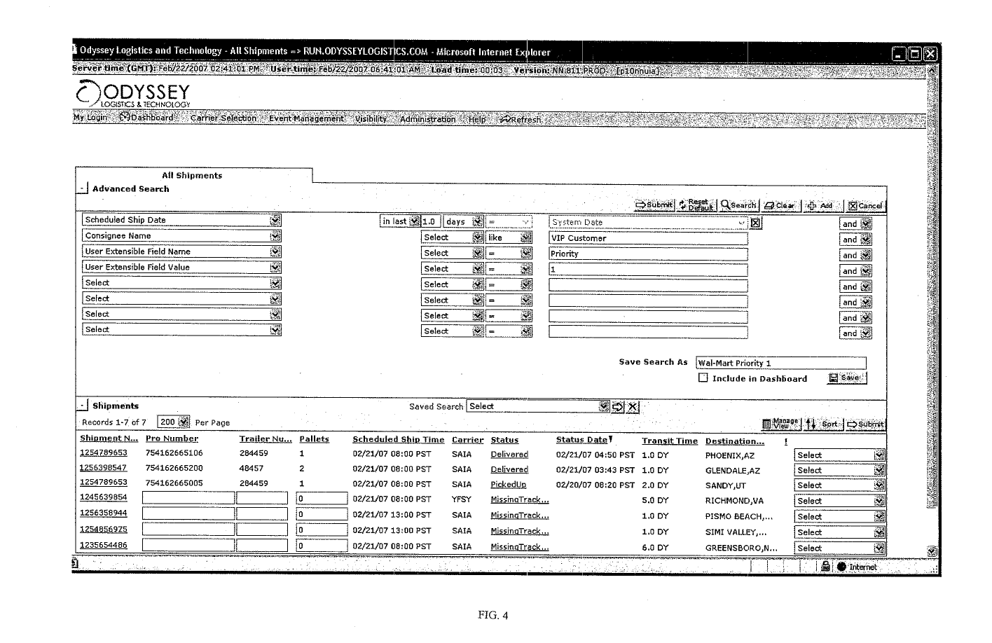

The Advanced Search option permits various groups of shipments to be found. For example, FIG. 4 shows the screen resulting from a search for all shipments scheduled to be shipped in the last day in which the consignee is “VIP Customer” and the shipment has a Priority of 1. The example of FIG. 4 shows 7 shipments resulting from the advanced search. Three of the shipments have been picked up or delivered. The tracking number is missing for four of the shipments and this is reflected in the status field.

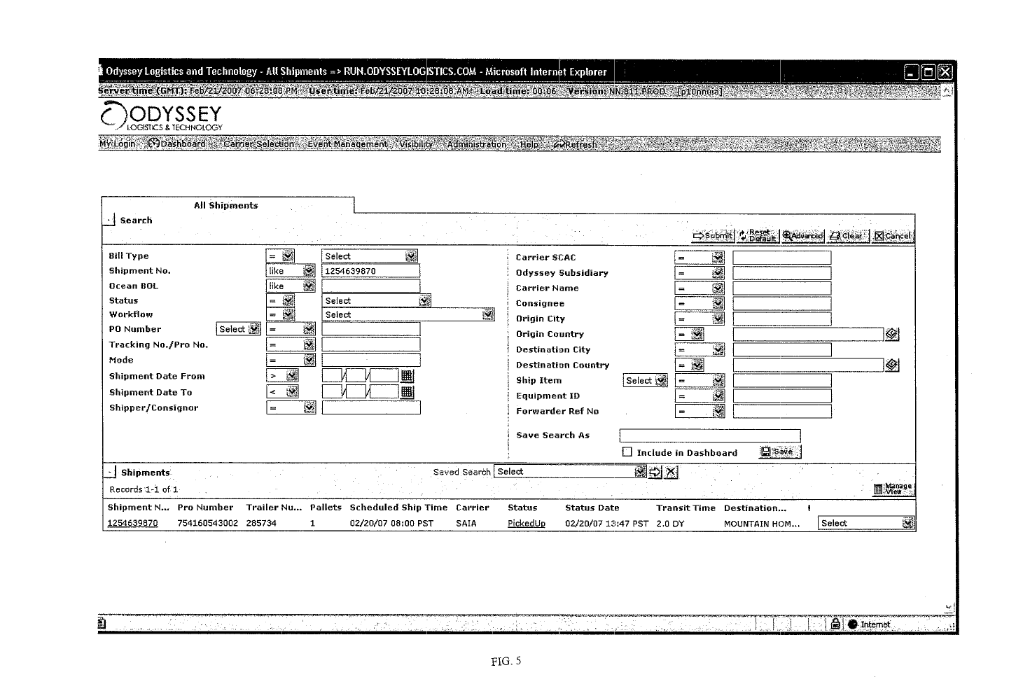

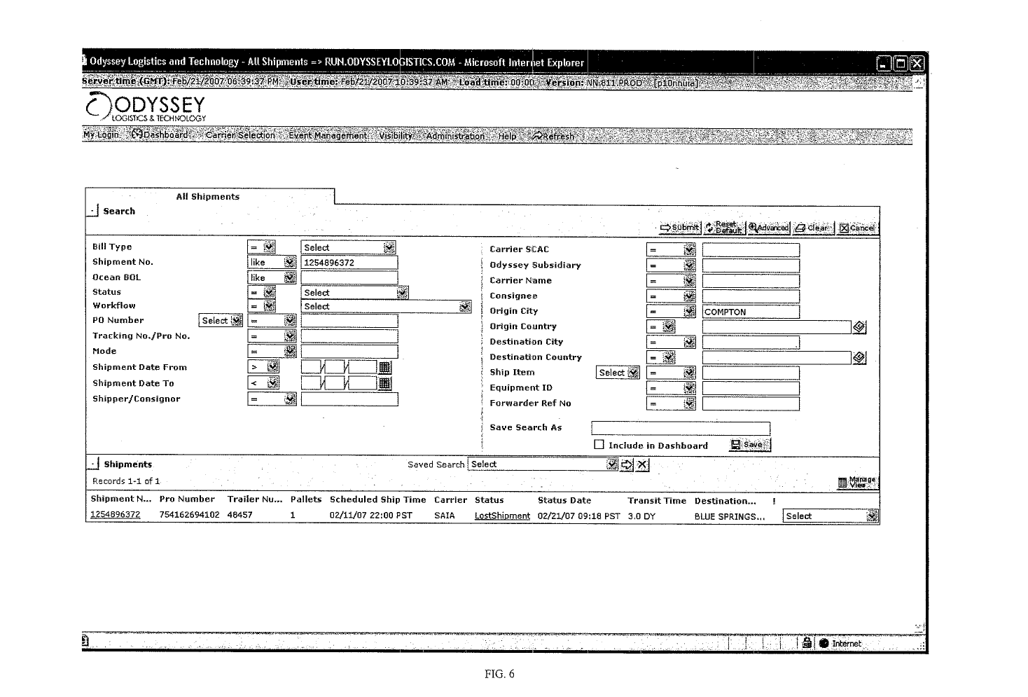

The status of a shipment can be checked at any time. This may be done for any reason, such as because the shipper/3PL customer calls to inquire about the status of a shipment. If a particular shipment is specified by shipment number, the corresponding record will be displayed as shown by FIG. 5. Because the shipment record is part of an integrated logistics system, when problems occur, such as a lost shipment as shown in FIG. 6, the 3PL or other party can be proactive in addressing the problems using the tracking number and trailer number. The tracking number and trailer number will appear as part of the shipment record.

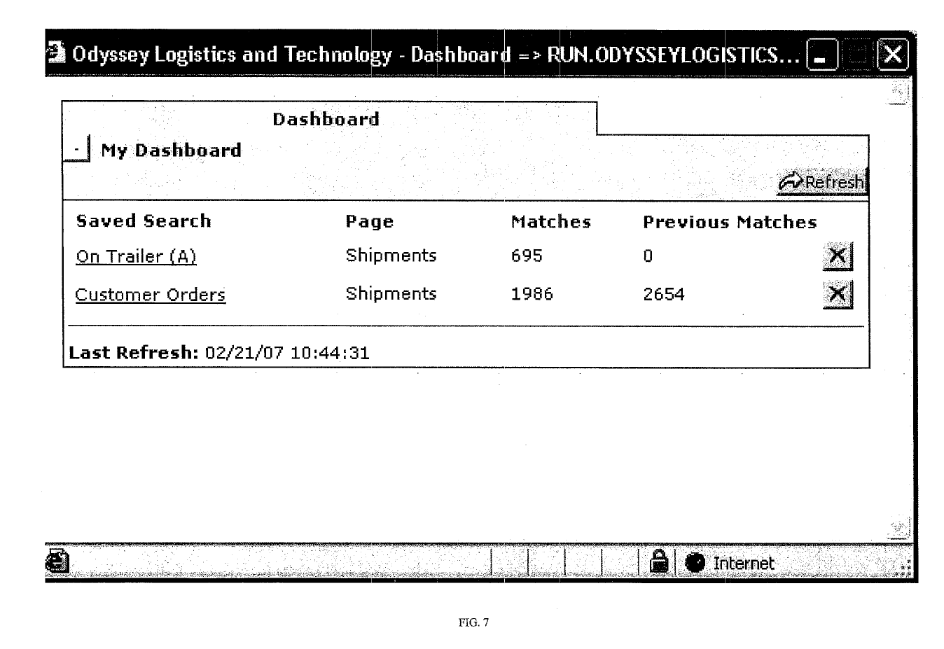

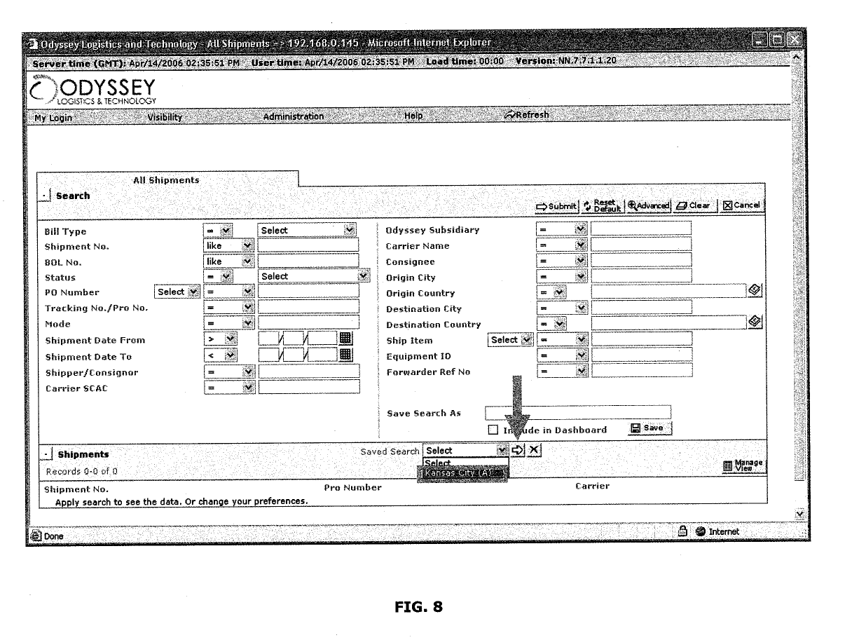

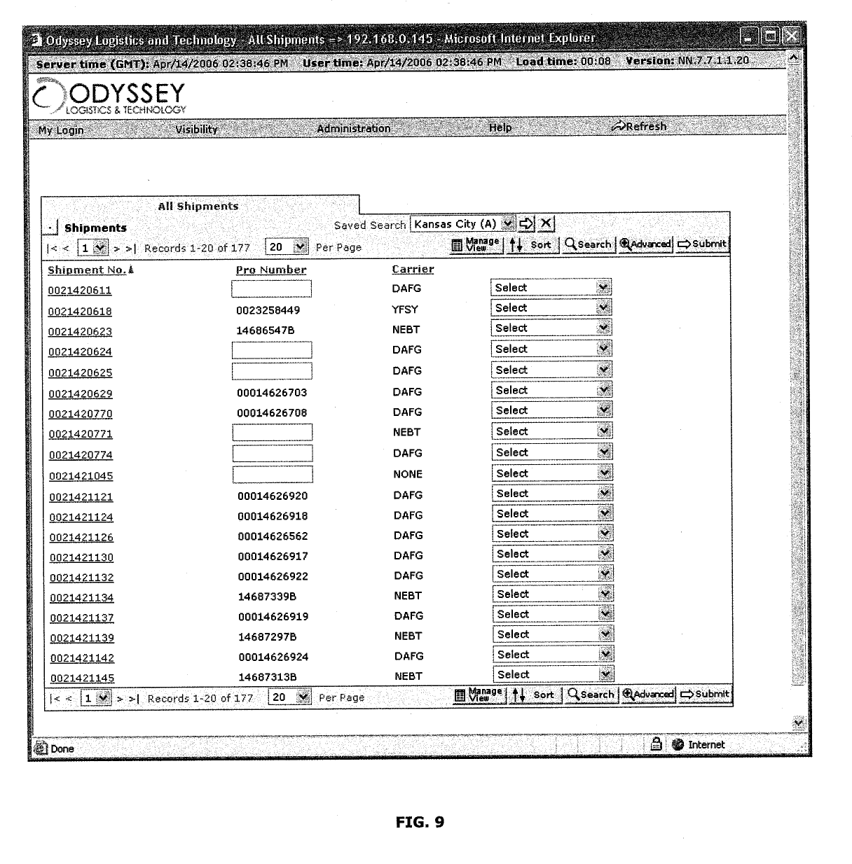

FIG. 7 shows a exemplary screen for the so-called Dashboard. It permits personnel to see how many shipments were in a customer's overnight order at a particular location, and to watch in real time or near real-time as they gradually loaded on a Trailer. In addition to the open search described above where searches can be done one at a time, the preferred embodiments also permit users to utilize a Saved Search feature. For example, a user working at a particular location can create and save a search for the shipments delivered to or shipped from that location. These searches can be named and accessible from a pull down menu. For example, FIG. 8 shows the selection of a search for all shipments from a Kansas City warehouse by selecting Kansas City from the list and clicking the little white arrow button. The resulting shipments are then displayed as shown in FIG. 9.

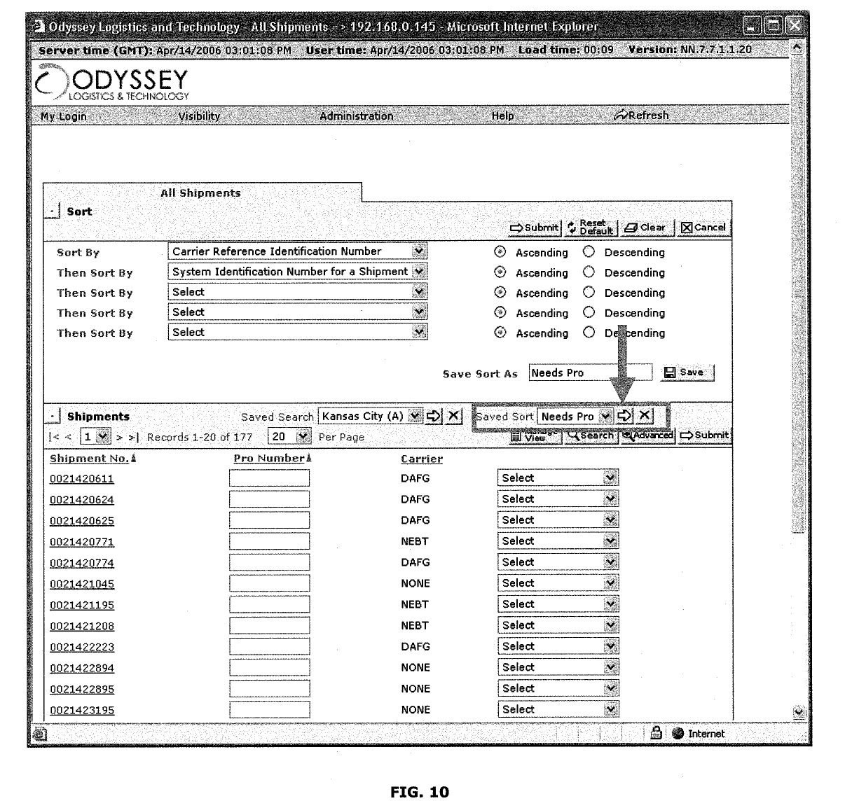

The shipments in the search results can preferably be sorted in a manner desired by a user. See FIG. 10. For example, the shipments can be sorted so that the shipments that need tracking numbers are on top, then sorted by shipment number. This is done by clicking the “Pro Number” column header (a little triangle appears next to the header) and then clicking the Sort button. Under the “Then Sort By” pull-down, select System Identification Number for a Shipment and keep the radio button set to Ascending. The Sort is named in the “Save Sort As” text box (for example, “Needs Pro”) and the Save button is clicked to save the named sort. Once a Saved Sort is created, the white arrow button is clicked to “commit” the saved sort.

These capabilities permit the status of shipments at a remote shipping location to be visible to other users, and to permit those other users to recognize problems and proactively resolve those problems. The presence of tracking numbers provides visibility and indicates real time information, such as that a shipment has been loaded on a truck. The logistics system may capture and make available the information of trailer ready and picked up in real time or near real time. Specific shipments can be searched for, and prioritized by personnel. Basic information regarding these shipments can be viewed in real time or near real time via a specialized dashboard. Users not at the shipping location can verify that shipments have been made. They can do this a plurality of bases and on a location-by-location basis if desired.

We claim as follows:

1. A method of tracking a shipment in an online integrated logistics system operated by a logistics service provider, said method comprising:
creating a shipment record in the online integrated logistics system corresponding to a shipment order received from a shipper;
receiving via a web-based interface from personnel at a shipment location a tracking number corresponding to the shipment order and storing said tracking number in said shipment record;
receiving via said web-based interface from the personnel at the shipping location status updates for said shipment order and storing said status updates in said shipment record, wherein said status updates indicate when a shipment corresponding to the shipment order has been loaded on a trailer, when the trailer is full and when the trailer has been picked up by a carrier; and
making the shipment record, including the tracking number and one or more of the status updates, available for viewing via the web-based interface.

2. The method of tracking a shipment according to claim 1, wherein the shipment record is available for viewing by the shipper and the personnel at the shipping location via the web-based interface.

3. The method of tracking a shipment according to claim 2, wherein the shipment record is also available for viewing by the carrier via the web-based interface.

4. The method of tracking a shipment according to claim 1, wherein the tracking number is received and stored in the shipment record prior to the shipment being loaded on the trailer.

5. The method of tracking a shipment according to claim 1, further comprising:
receiving via said web-based interface from the personnel at the shipping location a trailer number and a shipment size for the shipment; and
storing said trailer number and said shipment size in said shipment record.

6. The method of tracking a shipment according to claim 1, wherein the shipment order is received from the shipper's enterprise resource planning (ERP) system.

7. The method of tracking a shipment according to claim 1, wherein the shipment is a less-than-truckload shipment.

8. The method of tracking a shipment according to claim 1, further comprising sending the status updates for said shipment order to the carrier.

9. A method of tracking shipments in an online integrated logistics system operated by a logistics service provider, said method comprising:
creating shipment records in the online integrated logistics system, said shipment records corresponding respectively to shipment orders received from a shipper;
receiving via one or more web-based interface from personnel at one or more shipment location tracking numbers corresponding respectively to the shipment orders and storing said tracking numbers in the applicable shipment records;
receiving via said one or more web-based interface from the personnel at the one or more shipping location status updates for said shipment orders and storing said status updates in the applicable shipment records, wherein said status updates indicate when shipments have been loaded on trailers, when the trailers are full and when the trailers have been picked up by carriers; and
making the shipment records available for viewing via the web-based interface.

10. The method of tracking a shipment according to claim 9, wherein the shipment records are available for viewing by the shipper and the personnel at the one or more shipping location via the web-based interface.

11. The method of tracking a shipment according to claim 10, wherein the shipment records are also available for viewing by the carriers via the web-based interface.

12. The method of tracking a shipment according to claim 9, wherein at least some of the shipment orders are received from the shipper's enterprise resource planning (ERP) system.

13. The method of tracking a shipment according to claim 9, wherein at least some of the shipment orders are for less-than-truckload shipments.

14. The method of tracking a shipment according to claim 9, further comprising sending the status updates for said shipment orders to the applicable carriers.

15. An online integrated logistics system for tracking shipments comprising:
a TMS system containing shipment records corresponding respectively to shipment orders received from a shipper; and
a web-based interface for the TMS system enabling personnel at one or more shipping location to enter into said TMS system tracking numbers and status updates corresponding respectively to the shipment orders, wherein said status updates indicate when shipments have been loaded on trailers, when the trailers are full and when the trailers have been picked up by carriers; and
wherein the web-based interface makes the shipment records available on-line to the shipper and the personnel at the one or more shipping location.

16. The online integrated logistics system according to claim 15, wherein the web-based interface also makes the shipment records available on-line to the carriers.

17. The online integrated logistics system according to claim 15, wherein the web-based interface further enables personnel at the one or more shipping location to enter into said TMS system trailer numbers and shipment sizes for the shipments.

18. The online integrated logistics system according to claim 15, wherein at least some of the shipment orders are received from the shipper's enterprise resource planning (ERP) system.

19. The online integrated logistics system according to claim 15, wherein at least some of the shipment orders are for less-than-truckload shipments.

20. The online integrated logistics system according to claim 15, wherein the TMS system is configured for sending the status updates for said shipment orders to the applicable carriers.
